(19) United States
(12) Patent Application Publication
(10) Pub. No.: US 2018/0299294 A1
(43) Pub. Date: Oct. 18, 2018

(54) Abrasion-resistant and hydrolysis-resistant encoder, bearing unit with encoder and method for producing the encoder

(71) Applicant: Schaeffler Technologies AG & Co. KG, Herzogenaurach (DE)

(72) Inventors: Christian Mock, Schweinfurt (DE); Stefan Kurzbeck, Nürnberg (DE); Patrick Schmitt, Gerolzhofen (DE)

(73) Assignee: Schaeffler Technologies AG & Co. KG, Herzogenaurach (DE)

(21) Appl. No.: 15/776,412

(22) PCT Filed: Sep. 26, 2016
(86) PCT No.: PCT/DE2016/200448

§ 371 Date: May 16, 2018

(30) Foreign Application Priority Data
Dec. 2, 2015 (DE) 10 2015 223 977.2

(51) Int. Cl. G01D 5/12; B29C 45/14; B29C 45/16; B29C 45/00

(52) U.S. Cl. CPC G01D 5/12; B29C 45/14778; B29K 2073/00; B29C 45/0013; B29K 2995/0008; B29C 45/1671

(57) ABSTRACT

Encoder for bearing units are disclosed, as well as methods of making the encoders. In one example, an encoder includes a magnet part including a material which comprises polyketone and at least one magnetic filler. In an example method, an insert part is introduced into a mold, wherein the insert part is a support part, a metal foil or a metal-coated foil. The mold is closed and a melt is injected into the closed mold, wherein the melt includes a material which comprises polyketone and at least one magnetic filler. The melt may then be cooled, wherein the insert part joins with the melt to form the encoder.

### CROSS-REFERENCE TO RELATED APPLICATIONS

This application is the U.S. National Phase of PCT Appln. No. PCT/DE2016/200448 filed Sep. 26, 2016, which claims priority to DE 102015223977.2 filed Dec. 2, 2015, the entire disclosures of which are incorporated by reference herein.

### TECHNICAL FIELD

The disclosure relates to an abrasion-resistant and hydrolysis-resistant encoder. The disclosure further relates to a bearing unit comprising an encoder. The disclosure relates, moreover, to a number of methods for producing the encoder.

### BACKGROUND

Encoders have been known for a long time from the prior art. Magnetic encoders and magnetic field measurement sensors are used for the contactless capture of relative motions between stationary and moving machine parts. The encoder comprises a magnetic component, more particularly magnets, which along the direction of motion is provided with one or more alternating magnetizations, e.g., north-south pole.

The magnetic field measurement sensor detects this polarity switch and converts it into an electrical signal which is useful for a computer-assisted further-processing operation. The magnetic component of the encoder is generally fastened on a metallic support in order to allow the encoder to be mounted easily.

Magnet parts made of plastic are nowadays mostly manufactured from elastomeric materials, but in certain usage situations these materials exhibit inadequate abrasion characteristics. Among the more recent developments, therefore, are abrasion-resistant magnet parts made from thermoplastic materials.

The matrix material of the magnet parts nowadays manufactured from thermoplastics usually comprise polyamide 6 (PA6 for short) or polyamide 12 (PA12 for short), since, among the plastics materials, these polyamides exhibit high elongation and therefore relatively high flexibility even when the filler content is high. PA12, moreover, is notable for its high chemical resistance and good sliding friction characteristics.

Disadvantages of PA12 or PA6 are that these materials lack sufficient resistance to hydrolysis and are also unsuitable for relatively high continuous service temperatures. The continuous service range, depending on application, of unfilled PA6 is around 150° C. in the short term and around 85 to 90° C. over the long term, and the continuous service range of PA12 is around 140° C. in the short term and around 80° C. to 90° C. over the long term. Particularly in warm or hot water or on contact with steam, the materials suffer considerable damage or break down. Polyamides, moreover, have mechanical properties which are highly dependent on the moisture content; the abrasion resistance and the frictional characteristics as well are dependent on the moisture content and are adversely affected if the moisture level is too high. Consequently, encoders with a magnet part made from PA12 or PA6 have a lifetime which is inadequate in light of heightened requirements.

Plastics encoders, moreover, as is usual for thermoplastics, exhibit a tendency to creep, though this behavior differs in extent according to the particular plastic.

### SUMMARY

The technical problem addressed is therefore that of overcoming the disadvantages from the prior art and providing an encoder which retains consistent magnetization over the entire operating time and under the prevailing operating conditions.

The problem may be solved in accordance with the disclosure, in particular, by an encoder for bearing units wherein the encoder has a magnet part including a material which comprises polyketone and at least one magnetic filler.

By providing the polyketone with at least one magnetic filler it is possible to increase not only the abrasion resistance but also the hydrolysis resistance of the encoder. The polyketone with the at least one filler may be referred to as a compound.

By comparison with PA12, polyketone has a melting point which is higher by around 40° C. With this material, accordingly, it is possible to realize higher operating temperatures, this being true particularly, for example, in applications under hot and humid conditions. Polyketone likewise displays very good chemical resistance and, among thermoplastics in the dry state, has the greatest extension and therefore has a high flexibility. These aspects may be advantageous particularly at relatively high filler contents, as are needed in plastics encoders, and particularly in comparison to polyphenylene sulfide (PPS for short), which is likewise used for encoders, they reflect a decisive advantage.

The chemical resistance is able to expand significantly the range of possible lubricants, in comparison to PA12 and PA66. Thus polyketone withstands attack by light acids, which normally break down even long-chain polyamides, such as PA12. After 21-day storage in 10% hydrochloric acid or 30% sulfuric acid, the elongation at break remains at above 300%; polyketone is classified as resistant even to halogenated hydrocarbons and aldehydes. The reason for this is that polyketone is polymerized preferably from around 50% CO2 and there is therefore no congeneric solvent or congeneric chemical which is able to attack the material.

Moreover, polyketone may display identical properties in both the dry and wet states, whereas PA12 and PA66 display mechanical properties with a relatively strong to very strong dependence on the moisture content.

Also of advantage for the application is the relatively high hydrolysis resistance, which is much less pronounced for PA12 and PA66 and so may lead to aging and hence to the loss of mechanical properties at an earlier stage. Polyketone may display its resistance even in 100° C. water or steam.

Polyketones, moreover, display very good adhesion to metals, this being especially advantageous in view of the fact that the magnet part is to be applied to a metallic support. The resilience of the polyketone polymer is significantly higher than that of PA12, a factor which plays a major part in the case of deformations resulting from dynamic loads.

The magnet part preferably has a number of alternating north and south poles distributed uniformly over the circumference.

The bearing unit is preferably formed as a wheel bearing for commercial vehicles, trucks, automobiles, etc.

In one embodiment according to the disclosure, the filler comprises hard ferrites, iron, iron-containing compounds, or elements of the rare earths, or a combination of these fillers.

The encoder therefore has high resistance to abrasion. The rare earths are preferably neodymium or samarium.

In a further embodiment according to the disclosure, the fraction of the filler is 70 to 95 wt % of the material.

Accordingly, the resistance to abrasion is additionally increased. Further fillers which can be admixed are reinforcing fibers, examples being carbon fibers, aramid fibers, glass fibers, or glass beads, up to a fraction of 0.1 to 5 wt %. The abrasion resistance is increased as a result. The polyketone may include a flame retardant in the range from 0.1 to 5 wt %. One embodiment includes an additive for reducing the sliding friction, such as PTFE or MoS2 at 0.1 to 15 wt %, for example.

In a further embodiment according to the disclosure, a metal foil, a metal-coated foil or a metal coating is disposed or applied on the magnet part or an adhesion promoter is disposed between the metal foil, the metal-coated foil or the metal coating and the magnet part. The adhesion promoter is preferably a primer.

The provision of these components highlights possibilities for differently designing the encoder and adapting it to the particular installation scenario.

In a further embodiment according to the disclosure, the encoder comprises a support part, where the magnet part is applied on the support part or where an adhesion promoter is disposed between the support part and the magnet part.

Through the provision of the support part, the magnet part can be mounted on the bearing unit in a simple way. The support part is preferably made of metal, as for example a metal support sheet or a metal support. The metal support sheet is preferably an insert part.

The encoder is preferably produced by a one-component injection molding process, two-component injection molding process, injection-compression molding, or fluidized bed sintering. Highlighted accordingly are a number of possibilities for producing the encoder or components of the encoder.

The compound made up of polyketone and magnetic filler can be injected directly onto the support part in an injection molding process when adhesion is sufficient. A greater adhesive strength can be obtained by an adhesion promoter. In this respect as well, polyketone proves superior to PA12, since PA12 is relatively costly and inconvenient to attach. The adhesion promoter used may be a silane adhesion promoter in accordance with EP 1707923 B1.

With the injection molding process, the compound of polyketone and magnetic filler is preferably endowed with anisotropic magnetic characteristics, in order to increase the magnetic flux density attainable with the downstream magnetizing procedure.

As the pretreatment, e.g., activation, or primer layer it is possible to apply phosphatizing; other pretreatments such as roughening, pickling, and electrical discharges may be beneficial to the adhesion. It is possible, moreover, to use primers based on epoxy resin, on phenolic resin, on polyurethane, and on acrylate. For attaching polyketone by adhesion bonding to a support part, a two-component system may be used, since solvent-containing adhesions cannot be employed. Likewise conceivable here are two-component epoxy resins, phenolic resins, polyurethane resins, or acrylate resins. Preference may be given to using layer systems made up of two or more different primers to promote adhesion.

A connection to the metal support sheet can also be realized, preferably, via snap-fit connections, since even filled polyketone may exhibit high elongation. On its outer edge, the metal support sheet is preferably serrated or has notches, so that the plastics ring can be mounted on form-fittingly and in a manner proof against slippage.

As primers it is possible to use common resin systems, which establish a connection preferably by adhesion, adsorption or a chemical bond via COOH, OH or NH2 groups. Another possibility is to use hybrid polymers having functional groups which generate a chemical bond.

Table 1 below contrasts PA12 and polyketone.

TABLE 1

| Material | PA12 | Polyketone |
|---|---|---|
| Property | EMS - Grilamid | Akro - Polyketon |
| | 120 HFR | PK-VM |
| | conditioned | conditioned and dry |
| Tensile elastic modulus MPa | 1500 | 1500 |
| Elongation at break % | >50 | >200 |
| Melting temperature ° C. | 178 | 220 |
| max. service temperature ° C. | 80 | 110 |
| long term | | |
| max. service temperature ° C. | 150 | 180 |
| short term | | |

Polyketone offers significantly more possibilities for use as PA12, on account of better hydrolysis resistance, higher continuous service temperature, elongation at break, and chemical resistance. In comparison with PA66, polyketone likewise exhibits a higher hydrolysis resistance, elongation at break, impact toughness, and, moreover, a much lower water adsorption and higher chemical resistance. The elongation at break and impact toughness are important insofar as in operation the encoders are subject to severe dynamic loading, where pure polyketone displays no permanent deformation at up to 10% deformation. In this respect, polyketone is also superior to materials comprising PPS.

Furthermore, polyketone displays effective adhesion to metals, even without primer. To promote adhesion between magnet part and support part, it is possible with preference to use a primer layer composed of hybrid polymers, e.g., Ormocers™, on the support part, it being possible for this layer to be injection-molded on directly or onto which the softened/heated compound can be pressed in such a way as to impart shape.

As a result of the high extensibility it is also possible to join the plastic to the metal support sheet via snap-on connections (e.g., expanding button or rounded catch spring). The plastic can be applied directly in an injection molding or injection-compression molding process. Polyketone in this regard proves to exhibit very little warping, thus ensuring high dimensional integrity. This is an advantage in particular since segmented signals are tapped from the encoders, as magnetic components, and these signals are significantly clearer to read when there is little warping.

Another advantage of polyketone is that it very rapidly crystallizes, or solidifies, so allowing short cycle times to be realized, which is advantageous in relation to protecting the environment as well. A further advantage is that the material, through its outstanding chemical resistance, allows an extension to the range of lubricants.

The encoder preferably has a different construction from that which has been customary to date, namely magnetically filled plastic with primer and with metal support sheet. The encoder is preferably produced by a method wherein the magnet part filled with magnetic particles is coated with a metallic layer in a suitable thickness. In this case, the usual support part for magnetic information is disregarded or it is replaced by the coating.

The metallic layer can be applied by PVD (physical vapor deposition) processes, CVD (chemical vapor deposition) processes, by electroplating or by vapor deposition (e.g., electron beam, sputtering, etc.). Here it may be necessary to ensure that the substrate—that is, the plastic of the support part—is not damaged or partially or fully melted as a result of high temperature loading. The CVD layer may be built up, for example, from iron pentacarbonyl with or without carrier gas (e.g. H2). The applied layer can then be further sealed by an anticorrosion layer for improved durability.

In a further variant, the magnet part is applied to a foil. This is accomplished preferably by insert molding. The foil itself here may consist of a metallic material and may therefore provide magnetic gathering, hence allowing the attainable strength of the magnetization to be increased. The foil may have been coated with a primer. In one embodiment, the foil may be drawn as continuous product into the injection molding machine and be processed in the insert molding process, though it is also possible for the foil sections to be cut or punched into shape beforehand and used as an insert.

The foil may be shaped in an upstream machining step, which is also possible in the injection mold. In one embodiment, a thin adhesion promoter foil or a metal-coated foil or adhesion promoter foil is insert-molded with a compound. The plastic/adhesion promoter foil assembly can then be applied preferably to the support part (metal insert) or to a metal foil, preferably in a further method step.

A further possibility involves coating the metal support sheet with the magnetically filled plastic. This can be realized in a fluid-bed sintering process, in which a preheated support part is introduced into a bath of plastics powder, preferably a compound, and magnetic particles. The plastics powder may be fluidized by an airstream emerging from nozzles, with the particles remaining adhering on impingement onto the hot component. The attainable layer thicknesses are around 150 to 1000 μm; the layer thickness required for an optimum signal is around 700 μm.

It is also possible to apply the compound in a wet-chemical procedure, in other words in the form of particles in solution, in which case the support part or the metal foil may be coated after a primer has been applied beforehand. Another method which can be used is that of powder coating with the filler/plastic/compound powder.

A further possibility for positioning the polyketone material with magnetic particles (PK MP for short) in/on the bearing may be realized by adhering the compound directly onto the outer ring of the bearing with the support part. It is possible, moreover, to injection-mold the compound directly onto the outer ring.

A further possibility for processing involves processing the PK MP material by a two-component injection molding method with or without metal support sheet. In the case of processing with metal support sheet, the sheet may be inserted into the injection molding machine; in this case, the first component may be, for example, a primer plastic or primer elastomer (e.g., a thermoplastic elastomer), or, generally, a primer, and the second component may be the material. In the case of processing without metal support sheet, the first component may preferably be the material (e.g., PK MP). The second component, which may be a compound of polyketone filled with a shielding filler, e.g., highly filled compound with carbon fibers, or aluminum-filled compound, is preferably injection-molded onto the first component.

A further possibility is to injection-mold the material onto a mesh of fibers (carbon fibers or other shielding fibers), meaning that the fiber mesh may be intrinsically reinforced by a thermoplastic or thermoset. The polyketone material is preferably injection-molded on after the mesh has been inserted or after a reinforced mesh disc has been inserted into the injection molding machine. This may be done with or without primer.

Furthermore, the problem in accordance with the disclosure is solved in particular by a bearing unit comprising an encoder, as described above.

Furthermore, the problem is solved in accordance with the disclosure, in particular, by methods described herein.

The provision of the methods highlights various possibilities of producing an encoder for bearing units.

Preferably injection takes place by at least one device.

The support part may be made of metal. The encoder may comprise a magnet part including the material which comprises polyketone and at least one magnetic filler. In one embodiment, the material in the heated state is in the form of a melt.

In accordance with one embodiment, on injection of the melt into the mold, the mold may not be fully closed, allowing an embossing gap to form in the mold. In one embodiment, the melt is compressed in the mold by the action of pressure on the mold. As soon as the mold is closed, there is no longer an embossing gap.

In one method step the encoder is preferably magnetized; in other words, magnetic coding is applied. The encoder is preferably magnetized in a final method step.

### BRIEF DESCRIPTION OF THE DRAWINGS

The disclosure is now illustrated by way of example using figures, wherein:

FIG. 1 to FIG. 7 show example encoders of the disclosure,

FIG. 8 shows a bearing unit with an example encoder,

FIG. 9 shows an alternative bearing unit with an example encoder,

FIG. 10a to 10e show an example production method for an example encoder,

FIG. 11a to 11d show an alternative production method for an example encoder,

FIG. 12a to 12d show an alternative production method for an example encoder, and

FIG. 13a to 13e show a further alternative production method for an example encoder.

### DETAILED DESCRIPTION

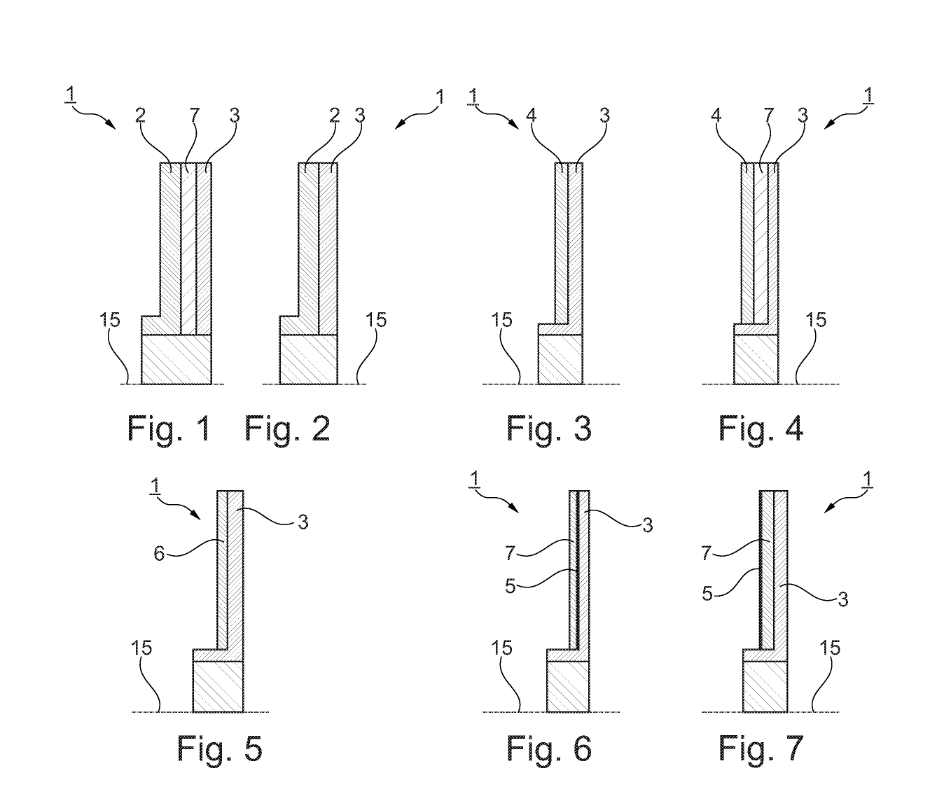

FIG. 1 to FIG. 7 show example embodiments. The disclosure is not confined to these embodiments. The encoder 1 shown in FIG. 1 to FIG. 7 comprises a magnet part 3. The magnet part 3 includes a material which comprises polyketone and at least one magnetic filler. The filler contains ferrite, iron, iron-containing compounds, or elements of the rare earths, or a combination of these fillers. The fraction of the filler is in the range from 70 to 95 wt % of the material. The encoder is annular in form.

In FIG. 1 the encoder 1 comprises a support part 2, a magnet part 3, and an adhesion promoter 7. The adhesion promoter 7 is disposed between the support part 2 and the magnet part 3. The support part 2 has an L-shaped cross section. The adhesion promoter 7 is a primer and in particular may also be an adhesion promoter foil. The support part 2, the magnet part 3 and/or the adhesion promoter 7 may be applied in a two-component injection molding process.

In FIG. 2 the encoder 1 has a support part 2 and a magnet part 3. The magnet part 3 bears flat against one side of the support part 2. The support part 2 has an L-shaped cross section. The support part 2 and/or the magnet part 3 may be applied in a two-component injection molding process.

In FIG. 3 the encoder 1 has a magnet part 3 and a metal foil 4. The metal foil 4 bears flatly against one side of the magnet part 3. The magnet part 3 has an L-shaped cross section.

In FIG. 4, the encoder 1 has a magnet part 3, a metal foil 4, and an adhesion promoter 7. The adhesion promoter 7 is disposed between the metal foil 4 and the magnet part 3. The magnet part 3 has an L-shaped cross section.

In FIG. 5 the encoder 1 has a magnet part 3 and a metal coating 6. The metal coating 6 bears flatly against one side of the magnet part 3. The magnet part 3 has an L-shaped cross section.

In FIG. 6 the encoder 1 comprises a magnet part 3, an adhesion promoter 7, and a metal-coated foil 5. The metal-coated foil 5 lies between the adhesion promoter 7 and the magnet part 3. The magnet part 3 has an L-shaped cross section.

In FIG. 7 the encoder 1 comprises a magnet part 3, an adhesion promoter 7, and a metal-coated foil 5. The adhesion promoter 7 lies between the metal-coated foil 5 and the magnet part 3. The magnet part 3 has an L-shaped cross section.

In addition to the encoders shown in FIG. 1 to FIG. 7, further dispositions of the individual components are also conceivable.

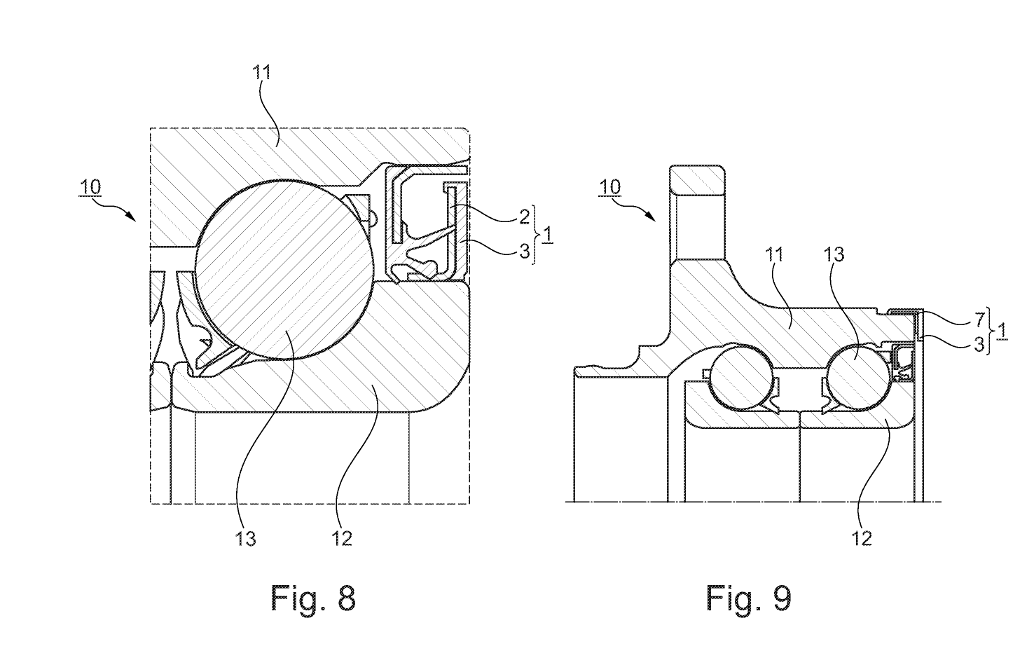

FIG. 8 shows the bearing unit 10. The bearing unit 10 comprises two bearing rings 11, 12, disposed radially one above the other, and rolling elements 13 revolving between them. Additionally, the bearing unit 10 has an encoder 1, which is formed of a support part 2 and a magnet part 3. The encoder 1 is disposed between the bearing rings 11, 12.

FIG. 9 shows an alternative bearing unit 10. The bearing unit 10 comprises two bearing rings 11, 12, disposed radially one above the other, and rolling elements 13 revolving between them. Additionally, the bearing unit 10 has an encoder 1, which is formed of a magnet part 3 and an adhesion promoter 7. The encoder 1 is adhered on a first bearing ring 11, e.g., the outer ring, without provision of a metal support sheet.

Alternatively, the encoder may also be injection-molded onto the first bearing ring 11. Application to the bearing ring 11 by injection molding may take place with or without adhesion promoter.

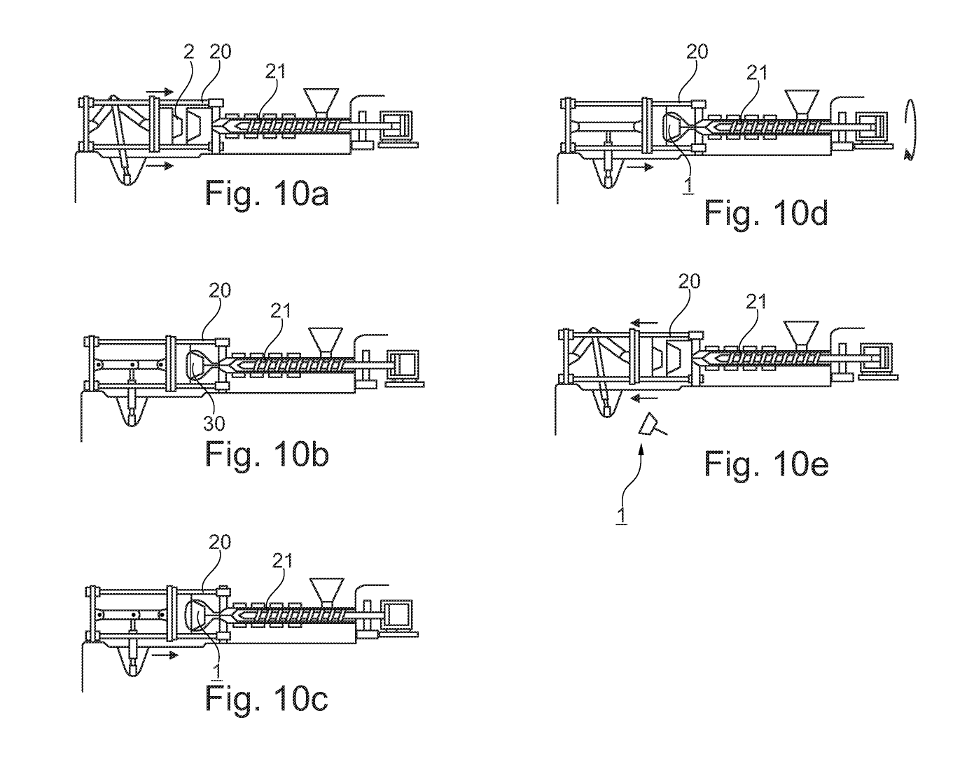

FIG. 10a to FIG. 13e show example embodiments. The disclosure is not confined to these embodiments. The encoders produced by the methods all comprise a magnet part including a material which comprises polyketone and at least one magnetic filler.

FIG. 10a to 10e show a first production method for an example encoder 1. The production method is a one-component injection molding process.

The first method for producing the encoder 1 for bearing units 15 comprises the following steps:
introducing an insert part into a mold 20, where the insert part is a support part 2,
injecting a melt 30 into the closed mold 20, where the melt 30 includes a material which comprises polyketone and at least one magnetic filler, and
cooling the melt 30, where the support part 2 joins with the melt 30 to form the encoder 1.

The support part 2 here may have been pretreated mechanically or by phosphating. Furthermore, an adhesion promoter may also be provided on the support part 2. The melt 30 is injected under the action of pressure. After cooling has taken place, the encoder 1 can be ejected or removed from the mold 20. The mold 20 in this case is part of an injection molding machine.

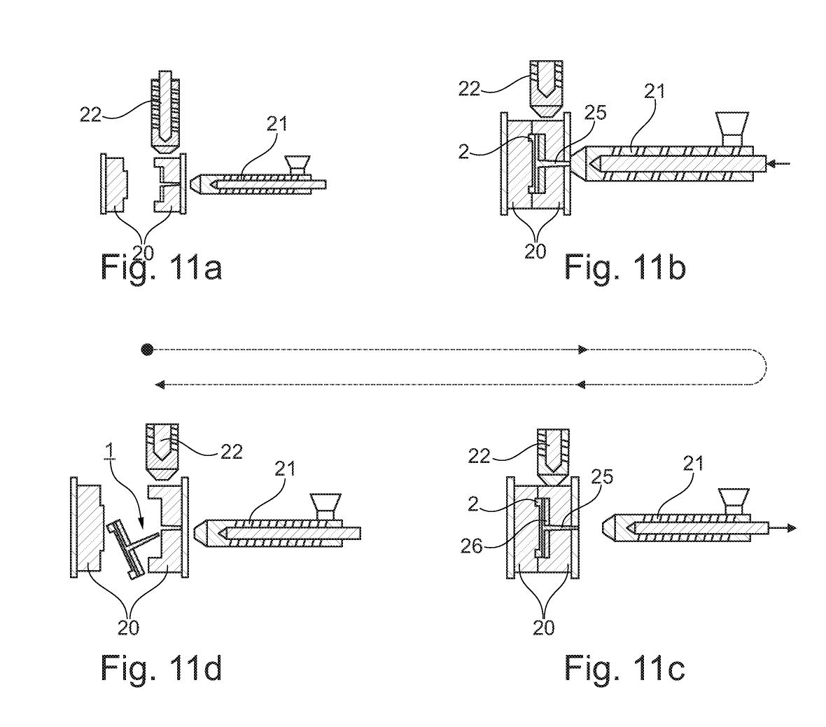

FIG. 11a to 11d show a second production method for an inventive encoder 1. The production method is a two-component injection molding process.

The second method for producing the encoder 1 for bearing units 15 comprises the following steps:
introducing an insert part into a mold 20, where the insert part is a support part 2,
injecting a first component 25 into the mold 20, where the first component 25 is an adhesion promoter,
cooling the first component 25, where the first component 25 joins with the support part 2,
injecting a second component 26 into the mold 20, where the second component 26 includes a material which comprises polyketone and at least one magnetic filler, and
cooling the second component 26, where the second component 26 joins with the first component 25 and in this way the encoder 1 is formed.

The support part 2 here may have been pretreated mechanically or by phosphating. The first component 25 and the second component 26 are injected under the action of pressure. Both components are flowable, and preferably are melts. After cooling has taken place, the encoder 1 can be ejected or removed from the mold 20. The mold 20, the first device 21, and the second device 22 here are parts of an injection molding machine.

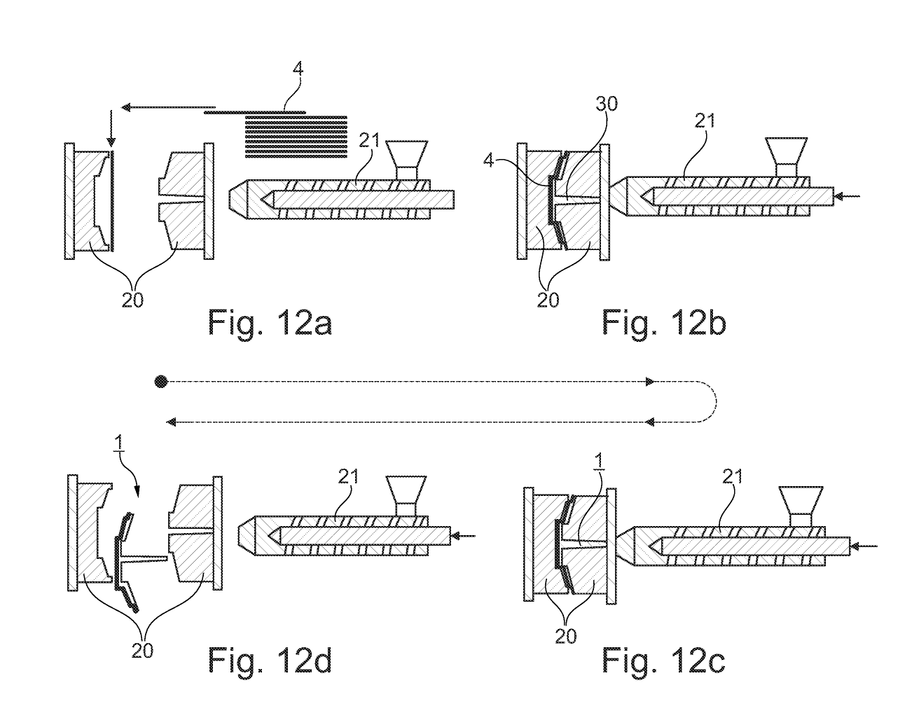

FIG. 12a to 12d show a third production method for an inventive encoder 1. The production method is an in-mold foil coating process.

The third method for producing the encoder 1 for bearing units 15 comprises the following steps:
introducing an insert part into a mold 20, where the insert part is a metal foil 4,
injecting a melt 30 into the mold 20, where the melt 30 includes a material which comprises polyketone and at least one magnetic filler, and
compressing the melt 30, where the melt 30 joins with the metal foil 4 to form the encoder 1 on cooling of the melt 30.

Furthermore, there may also be an adhesion promoter provided on the metal foil 4. When the mold 20 is pressed together, the metal foil 4 inserted into the mold 20 is embossed in correspondence with the shape of the mold 20. The melt 30 is injected under the action of pressure. After cooling has taken place, the encoder 1 can be ejected or removed from the mold 20. The mold 20, the first device 21, and the second device 22 here are parts of an injection molding machine.

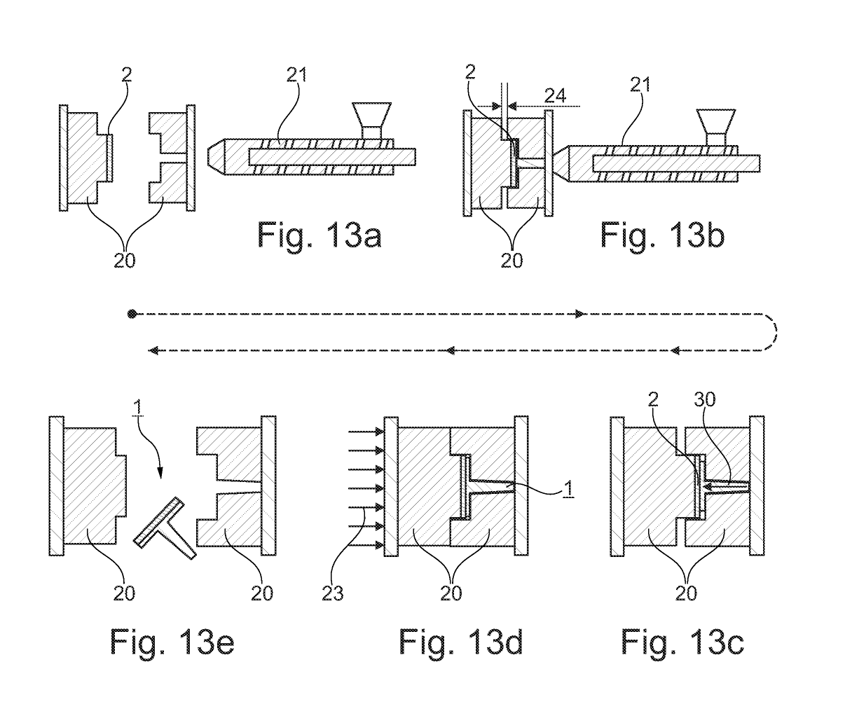

FIG. 13a to 13e show a fourth production method for an inventive encoder 1. The production method is an injection-compression molding process.

The fourth method for producing the encoder 1 for bearing units 15 comprises the following steps:
introducing an insert part into a mold 20, where the insert part is a support part 2,
injecting a melt 30 into a mold 20 by a first device 21, where the melt 30 includes a material which comprises polyketone and at least one magnetic filler, and
compressing the melt 30, where the melt 30 joins with the support part 2 to form the encoder 1 on cooling of the melt 30.

The support part 2 here may have been pretreated mechanically or by phosphating. Furthermore, there may also be an adhesion promoter provided on the support part 2. When the melt 30 is injected into the mold 20, the mold 20 is not completely closed, and so an embossing gap 24 is able to form in the mold 20. As a consequence of action of pressure, 23, on the mold 20, the melt 30 is compressed in the mold 20. As soon as the mold 20 is closed, the embossing gap 24 no longer exists. After cooling has taken place, the encoder 1 can be ejected or removed from the mold 20. The mold 20, the first device 21, and the second device 22 here are parts of an injection machine.

A fifth production method, though not shown, is a fluidized sintering process.

The fifth method for producing the encoder 1 for bearing units 15 comprises the following steps:
heating a support part,
introducing the support part into a bath of plastics powder, where the plastics powder comprises polyketone and at least one magnetic filler, more particularly magnetic particles, and where the plastics powder is fluidized by an airstream, and
impinging the magnetic particles onto the support part, with the plastics powder remaining adhering on the support part.

Furthermore, there are also additional methods envisaged for producing an encoder for bearing units. Methods include the following:
PVD methods (physical vapor deposition methods),
CVD methods (chemical vapor deposition methods),
electroplating or vapor deposition (e.g., electron beam, sputtering, etc.).

The provision of the methods highlights different possibilities for producing an encoder for bearing units.

List of reference numerals

| | |
|---|---|
| 1 | encoder |
| 2 | support part |
| 3 | magnet part |
| 4 | metal foil |
| 5 | metal-coated foil |
| 6 | metal coating |
| 7 | adhesion promoter (=primer) |
| 10 | bearing unit |
| 11 | bearing ring |
| 12 | bearing ring |
| 13 | rolling element |
| 20 | mold |
| 21 | device |
| 22 | device |
| 23 | action of pressure |
| 24 | embossing gap |
| 25 | component |
| 26 | component |
| 30 | melt |

1. An encoder for bearing unit, comprising:
an encoder including a magnet part including a material which comprises polyketone and at least one magnetic filler.

2. The encoder as claimed in claim 1, wherein the at least one magnetic filler comprises hard ferrites, iron, iron-containing compounds, or rare earth elements, or a combination of these fillers.

3. The encoder as claimed in claim 1, wherein a fraction of the filler is 70 to 95 wt % of the material.

4. The encoder as claimed in claim 1, wherein a metal foil, a metal-coated foil, or a metal coating is disposed or applied on the magnet part or an adhesion promoter is disposed between the metal foil, the metal-coated foil or the metal coating and the magnet part.

5. The encoder as claimed in claim 1, wherein the encoder comprises a support part, wherein the magnet part is applied on the support part or wherein an adhesion promoter is disposed between the support part and the magnet part.

6. A bearing unit comprising an encoder as claimed in claim 1.

7. A method for producing an encoder for bearing units, comprising the following steps:
introducing an insert part into a mold, wherein the insert part is a support part, a metal foil or a metal-coated foil,
closing the mold,
injecting a melt into the closed mold, wherein the melt includes a material which comprises polyketone and at least one magnetic filler, and
cooling the melt, wherein the insert part joins with the melt to form the encoder.

8-10. (canceled)

11. The method of claim 7, wherein the insert part is a support part and the support part is pretreated mechanically or by phosphating.

12. The method of claim 7, wherein the insert part is a support part and an adhesion promoter is provided on the support part.

13. An encoder for bearing unit, comprising:
a magnet part including a material which comprises polyketone and at least one magnetic filler; and
a support part;
wherein the magnet part is applied on the support part or wherein an adhesion promoter is disposed between the support part and the magnet part.

14. The encoder as claimed in claim 13, wherein the at least one magnetic filler comprises hard ferrites, iron, iron-containing compounds, or rare earth elements, or a combination of these fillers.

15. The encoder as claimed in claim 13, wherein a fraction of the filler is 70 to 95 wt % of the material.

16. The encoder as claimed in claim 13, wherein a metal foil, a metal-coated foil, or a metal coating is disposed or applied on the magnet part or an adhesion promoter is disposed between the metal foil, the metal-coated foil or the metal coating and the magnet part.

17. A bearing unit comprising an encoder as claimed in claim 13.
